(19) United States
(12) Patent Application Publication
(10) Pub. No.: US 2012/0136495 A1
(43) Pub. Date: May 31, 2012

(54) MONITORING OF AN INSTALLATION ON THE BASIS OF THE DANGEROUSNESS ASSOCIATED WITH AN INTERACTION BETWEEN SAID INSTALLATION AND AN ANIMAL SPECIES

(75) Inventors: Hubert Lagrange, Plaissan (FR); Frederic Melki, Loupian (FR)

(73) Assignee: BIOTOPE, MEZE (FR)

(21) Appl. No.: 13/389,089

(22) PCT Filed: Aug. 5, 2010
(86) PCT No.: PCT/FR2010/051661

§ 371 Date: Feb. 6, 2012

(30) Foreign Application Priority Data
Aug. 7, 2009 (FR) 09 55587

(51) Int. Cl. G06F 1/26

(52) U.S. Cl. 700/287

(57) ABSTRACT

Disclosed is a method for monitoring an installation having a first level of dangerousness for an animal species in a first operating state (E₁), the method including a step (107) in which the installation is switched to a second operating state (E₂) in which the installation has a second lower level of dangerousness. The installation is switched to the second operating state on the basis of at least one criterion linked to the activity of the animal species or on the basis of a multivariate model for predicting the activity. Also disclosed is a computer program including instructions for implementing the method, to a device for implementing same, and to a system including such a device.

The invention relates to the monitoring of an installation according to the dangerousness of its interaction with an animal species in its environment, and in particular the monitoring of wind turbines that are inherently dangerous for some species of flying animals.

The multiplication of manmade installations in the natural environment often impacts on the problems related to the cohabitation of some animal species living or transiting in close proximity to these installations.

On one hand, the animal species transiting in close proximity to these installations can be endangered by the operation of these installations. Reciprocally, these installations can be damaged by these animal species, for example, as a result of accidental collisions with members of these species.

A concrete example of these types of installations which present a potential for dangerous interaction with these animal species is associated with wind turbines.

Indeed, encouragement for the development of renewable energies leads to the study of numerous projects for the installation of wind farms on various sites within the territory.

On these sites, the operation of these wind turbines often presents a danger for flying species. This is particularly true for the order chiroptera of which the species, commonly known as bats, can be seriously affected by these types of installations.

In addition to be directly harmful to these species, this fact induces a financial problem. Indeed, all new projects for the installation of wind turbines are subject to review by public bodies and environmental agencies (such as the DIREN in France), which may issue a negative decision in an effort to ensure the survival of protected chiroptera.

Therefore, the installation of new wind farms on the territory is limited to those sites which do not show significant chiroptera activity as a precautionary measure for the preservation of these species; most of which are protected in France and the European Union. Even where a public body decision is not strictly negative, it will often require that the developer reduces the number of proposed wind turbines, or uses only part of the area included in the initial study. The result is therefore a reduction in the project's financial return, or perhaps its abandonment.

Wind turbine control systems aimed at reducing their dangerousness in respect of flying species have been developed. A first solution was the object of an international application WO 2007/038992 A1, in the name of Daubner & Stommel GBE Bau-Werk-Plannug.

In this first solution, a wind turbine is presented with an on-board detection device. This device, for example, infrared, is able to detect the presence of an animal such as a bat and cause the wind turbine to stop.

However, this present solution presents a disadvantage in that it requires the presence of a detection device directly on the wind turbine. In an existing wind farm, this solution therefore requires the adaptation of existing wind turbines through the installation of a device on each of the wind turbines; an operation which is intensive and costly to carry out.

Furthermore, this type of device requires that the signal to shut down the wind turbine is given at the moment when the animal is effectively detected; that is to say when the animal is at a very short distance from the blades and that collision is imminent. Whereas, since it takes at least one minute to fully shut down a wind turbine, it is very likely that the collision will have already occurred before this time. It is therefore unrealistic to imagine that such a device can be really effective for the protection of flying animals.

The present invention is aimed at providing a solution to the aforementioned drawbacks.

One of the objects of the present invention consists of proposing a simple method for monitoring an installation, so that the said installation can be switched to a particular operating mode that presents a lower level of dangerousness with respect to the interaction between the installation and an animal species living or transiting nearby the installation, based on the activity of this animal species.

In particular, one of the objects of the present invention consists of proposing a simple method for monitoring an installation, so that the said installation can be switched to an operating mode that is less dangerous for an animal species living or transiting nearby the installation, based on the activity of this species.

Another object of the present invention consists of proposing a monitoring method for an installation, so that the said installation can be switched to an operating mode that reduces the potential risk of damage caused to the installation by an animal species living or transiting nearby the installation, the species having a high level of activity.

Another object of the present invention is to take into consideration, when monitoring the installation, any loss in production caused by the switching of the installation to a less dangerous mode.

Another object of the present invention is to create a model of animal activity from multidimensional systems modelled by decision trees, mathematical formulas or neural networks.

To this end, the present invention proposes a method for monitoring an installation, based on the activity of an animal species, the said installation presenting at least a first state of operation and a second state of operation respectively associated to a first and second level of dangerousness due to interaction between the installation and the animal species, the second level of dangerousness being lower than the first level of dangerousness, the method comprising a step for switching the installation from the first state of operation to the second state of operation, characterised in that the switching is implemented on the basis of at least one criterion related to the activity of the animal species.

In one preferred embodiment, the switching is carried out during at least a period of time determined by the activity of the animal species, this permitting a programmed and simplified management of the switch over process.

Advantageously, the method comprises a prior step of determining the period of time using a parameter of activity of the animal species during a certain time period.

In a preferred embodiment, the switching is implemented on the basis of the comparison of at least one measured climatic parameter with at least one threshold value.

In preference, the method comprises a step of measuring the climatic parameter at a distance which is less than a proximity limit distance. This makes it possible to ensure that the climatic conditions used to decide whether to switch operating modes are indeed those which apply in the vicinity of the installation.

In a preferred embodiment, the switching is implemented if the measured wind speed is less than a first threshold value.

In a preferred embodiment, the switching is implemented if the measured temperature is higher than a threshold value.

In preference, the switch over is also implemented based on a criterion linked to the installation's efficiency. This makes it possible to reach a compromise between the protection of the endangered animal species and the optimum use of the installation.

In preference, the switching is implemented if the wind speed is less than a second threshold value.

In preference, the second state of operation corresponds with a shut down state of the installation, which will make it possible to completely eliminate the dangerousness of the installation.

In a particular embodiment, the installation is an installation which converts wind energy into electrical energy and the animal species is a flying species. In a more particular embodiment, the flying animal species belongs to the order chiroptera.

The present invention is also aimed at a monitoring device capable of being connected to at least one installation and switching the said installation from a first state of operation to a second state of operation, and which includes the appropriate means for implementing a process such as described here-above and sending a change-of-state signal to the said installation.

The present invention is also aimed at a system monitored on the basis of dangerousness related to the activity of an animal species, comprising at least one installation which can be operated in at least a first operating state and a second operating state associated respectively to a first and a second level of dangerousness due to interaction between the installation and the animal species, the second level of dangerousness being inferior to the first level of dangerousness, the system comprising a monitoring device as described here-above, connected to the said installation and able to send it a change-of-state signal.

In addition, the present invention is also aimed at a computer programme which can be downloaded via a telecommunication network and/or stored in a memory of a central unit and/or stored on a memory device designed to cooperate with a reader of the said central unit, characterised in that it comprises instructions for implementing the steps of a process as described here-above.

The method, the device, the system and the computer programme concerned by the present invention, will be better understood when reading the description and observing the drawings below in which:

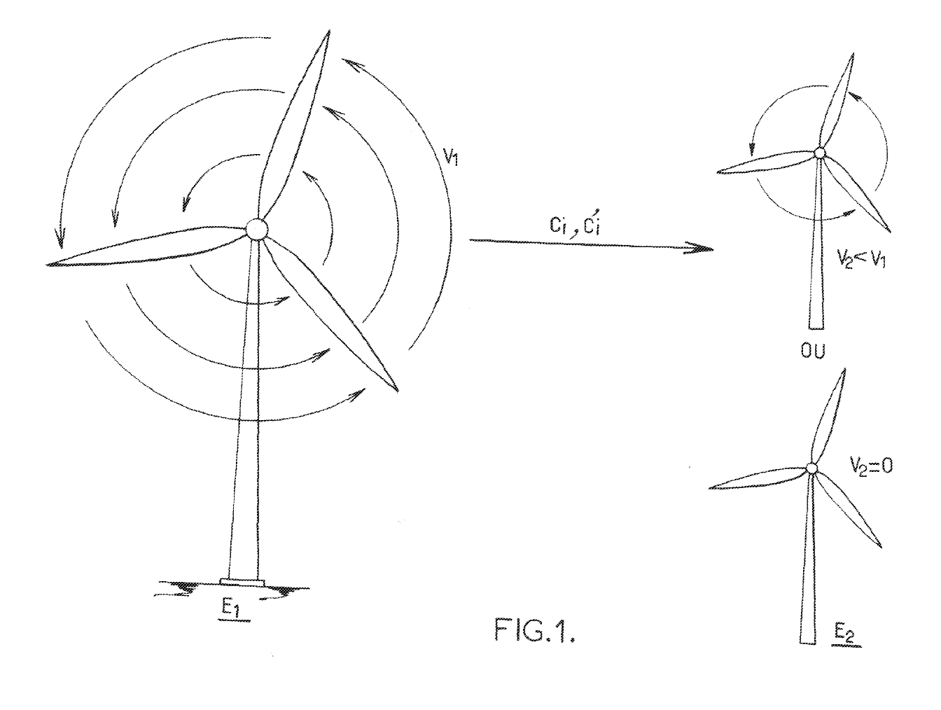

FIG. 1 is a diagram illustrating the general principle of the present invention;

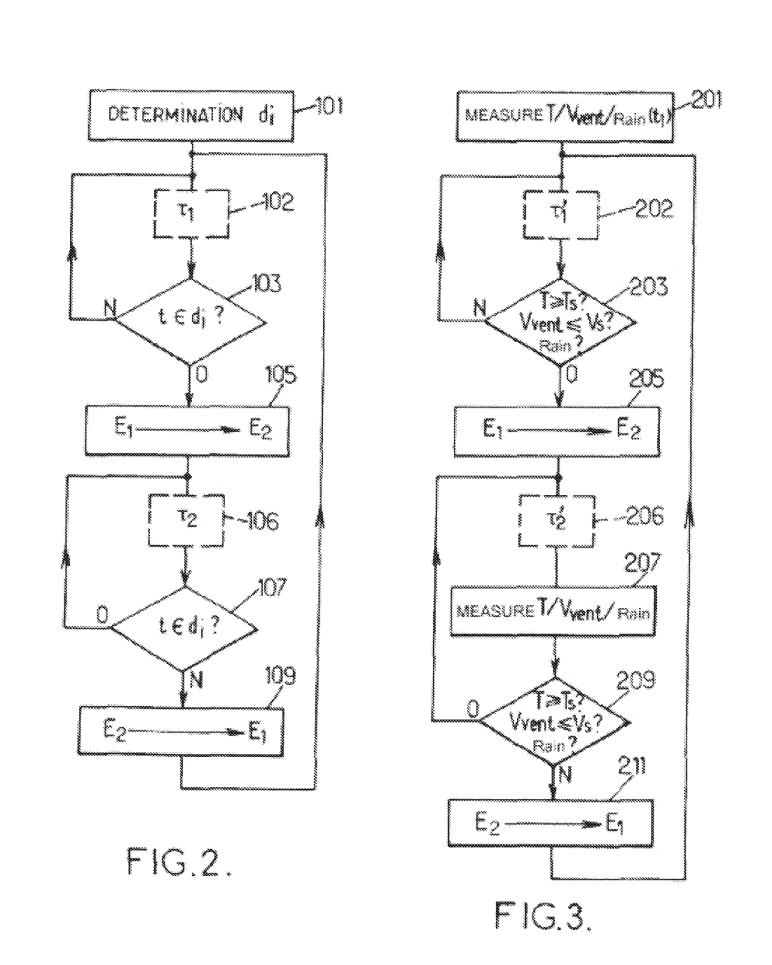

FIG. 2 illustrates the steps of a method for monitoring an installation according to a first embodiment of the invention;

FIG. 3 illustrates the steps of a method for monitoring an installation according to a second embodiment of the invention;

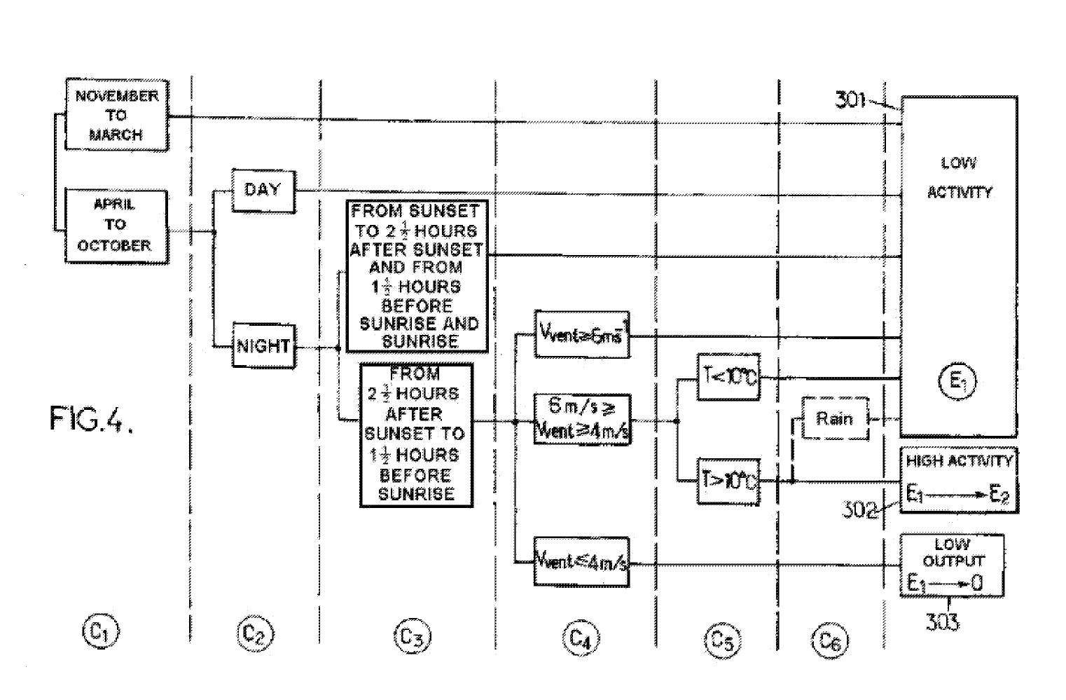

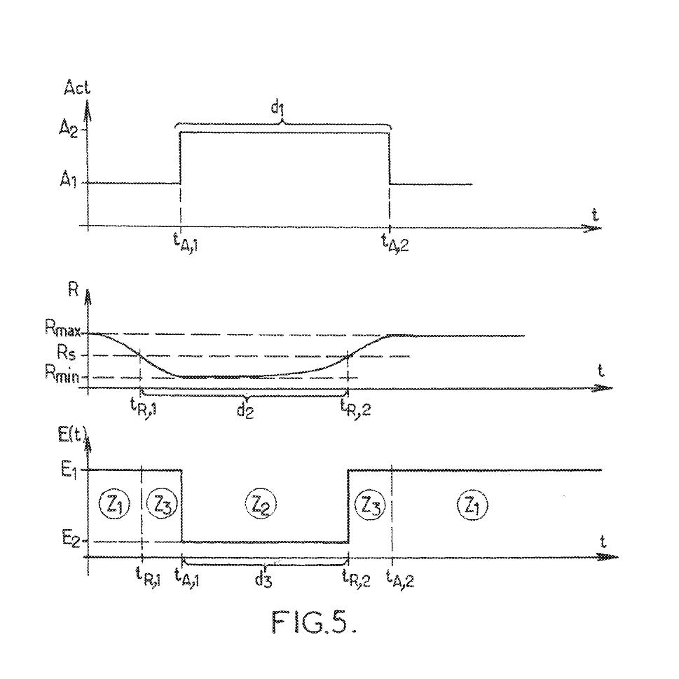

FIG. 4 is a tree structure illustrating the switching of a wind turbine into a mode of operation according to various criteria which influence the activity of bats;

FIG. 5 illustrates the consideration of the efficiency of the installation to be monitored by the method according to the present invention; and

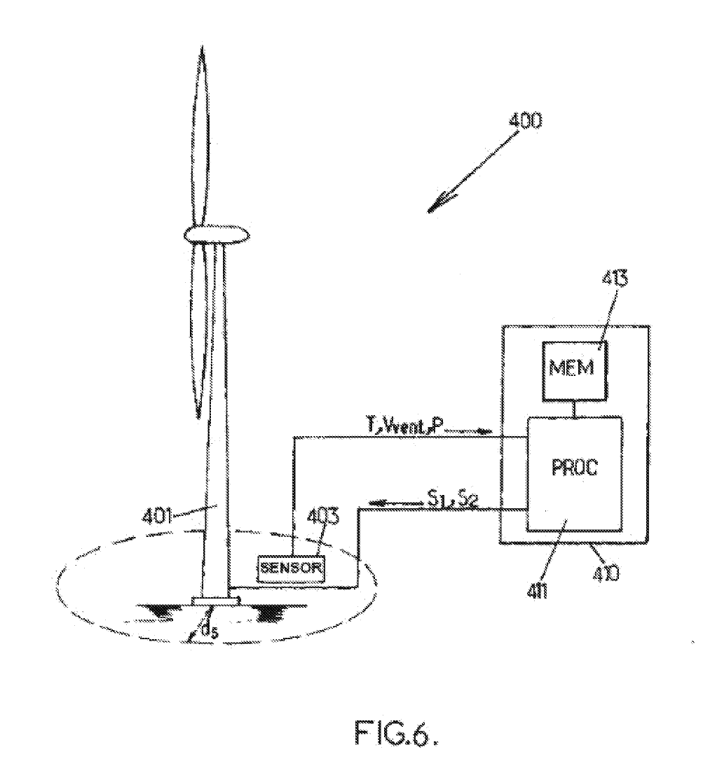

FIG. 6 illustrates a wind turbine monitoring system using the method according to the invention.

We refer, first of all, to FIG. 1 in which the general principle of the invention is illustrated.

The method of the present invention can be applied to all installations presenting at least two operating states E₁ and E₂. “Installation” is hereby understood to mean any manmade equipment or device potentially interacting with one or several animal species.

This potential interaction between such an installation and an animal species living or transiting in close proximity to the said installation involves a certain level of dangerousness, due to this interaction, either for the animal species of which members can be injured by the installation during its operation, or for the installation which can be damaged by the members of an animal species (for example as the result of an accidental collision).

In the first case, the level of dangerousness due to this interaction equates to a level of dangerousness for the animal species and can, for example, be characterised by an average mortality rate of this species caused by the operation of the installation in a first operating state E₁.

In the second case, the level of dangerousness due to this interaction equates to a level of risk of damage to the installation and can, for example, be characterised as a probability of damage to the installation caused by a member of the animal species present in its environment during operation of the installation in a first operating state E₁.

Therefore, the installation presents a first level of dangerousness, due to interaction between the installation and an animal species, in its first operating state E₁ which can simply be its normal operating state.

The idea of the present invention is to switch the installation, on the basis of activity of the animal species in question, to a second operating state E₂ in which the installation presents a lower level of the dangerousness caused by this interaction, for example, a lower level of dangerousness for the animal species in question (which can be reflected, for example, by a lower mortality rate in the E₂ state than that of the first state E₁), or indeed a reduced level of risk of damage to the installation.

In particular, during periods of increased activity of the animal species, it is appropriate to implement such a switch over in order to reduce the risk of accident for the animal species and/or damage to the installation in question.

FIG. 1 illustrates a wind turbine of which the first operating state E₁ corresponds to the rotation of blades at a given V₁ speed. This presents a danger to flying species in its proximity. The second operating state E₂ consists of using a reduced rotating speed V₂ of blades (where V₂<V₁) in order to reduce the level of danger to the flying species. In a particular embodiment, the second state E₂ consists of stopping the blades from rotating (i.e. V₂=0).

In this specific example, the level of risk of damage to the wind turbine linked to state E₁, where the rotation speed is higher, is superior to the level of risk of damage to the wind turbine linked to state E₂, because a collision with a member of a flying species will be less violently affected by the kinetic energy of the wind turbine. A fortiori, when the second state consists of stopping the rotation of the blades (i.e. V₂=0), the level of risk of damage is minimum since the wind turbine thus produces zero kinetic energy.

In the present invention, switching from the first state E₁ to the second state E₂ is implemented on the basis of at least one criterion Ci (or of several criteria Cj, Cj′) linked to the activity of the animal species, for example by a causal link. Such a criterion can, moreover, be of a temporal or climatic nature.

In a first embodiment, illustrated by FIG. 2, a temporal criterion is used. Temporal criterion here refers to a period of time, potentially periodic, during which the animal species presents a level of activity that exceeds a certain threshold and therefore the greatest risk that a member of this species will be injured or killed by the installation

The method according to the first embodiment consists therefore, during a step 105, of switching the installation from a first operating state E₁ to a second, less dangerous operating state E₂, during a period of time which corresponds with a period of high activity of the endangered animal species, which is symbolised by the verification step 103 in FIG. 2.

In a first example which takes into consideration the annual periodicity of the activity of chiroptera threatened by wind turbines, it is known that they are not very active in winter, from November to March, whereas they are considerably more so from April to October. Therefore, in a first embodiment, we can envisage simply switching the wind turbine to its second operating state during a period, known to be highly active for chiroptera, which runs from April to October. This period of high activity varies of course according to geographical zones and climatic conditions.

In a second, more refined example taking into consideration the daily periodicity of the activity of chiroptera, their activity is particularly more important during the night time than it is during daytime, in particular during some hours each day, after sunset and a few hours before sunrise. We can therefore, in another embodiment, envisage switching the wind turbine to its second operating state each day during the period dᵢ of most intense darkness described here-above.

It is of course possible to combine these two previous examples to create an optimum embodiment in which the wind turbine switches to its second operating state each day from April to October, and only during the periods of most intense darkness described here-above. Such a mode makes it possible to maintain the wind turbine in its first operating state, presenting a better rate of production, during the daytime periods of spring and summer.

It is of course possible to envisage the use of other time periods during which chiroptera activity is affected. For example, the full moon is a periodic factor which causes a reduction in chiroptera activity. We can therefore consider those nights which have a full moon as an additional criterion and not switch the installation to the second state during those nights.

The time periods indicated here-above are advantageously determined by using preliminary statistical studies and by creating multivariate models to describe the level of chiroptera activity over a more or less long period.

To do this, the monitoring method can comprise a step 101 of determining at least one time period during which the activity of the species, or of the group of animal species, exceeds a certain activity threshold. This determination can be done by measuring the activity of the animal species in proximity to the installation during a certain time period and by its analysis.

This activity can be measured using automated passage recording devices, based for example, on passive systems for detecting sound or ultrasound, photograph or video capture of the visible or infrared spectrum, detection of movement. Active systems, such as radars, sonars, lidars, infrared illuminators and associated imagery which can include movement detectors can also be used.

Once the second operating state E₂ is implemented, it is possible to keep on verifying, at regular intervals, during a verification step 107, that we are still in a high activity time period dᵢ.

If it's no longer the case then it can be useful to switch back the installation, during a 109 step, to its first operating state E₁ if this one produces a better efficiency than the second state E₂. This is particularly the case for a wind turbine which has an efficiency that is proportional to the rotation speed of its blades, which is superior in the E₁ state compared to the E₂ state.

Advantageously, the optional time delay steps 102 and 106 can be included to insert a time delay T₁, respectively T₂, between two successive verification steps 103, 105 respectively. This makes it possible to adapt the responsiveness of the system by the choice of more or less long time delays T₁ and T₂.

In a second embodiment, illustrated by FIG. 3, “a criterion of a climatic nature” is hereby understood to mean the comparison with a predefined threshold of all climatic parameters characterising the climatic conditions surrounding the considered installation and influencing the behaviour of the species threatened by that installation.

The method according to the second embodiment consists therefore of switching the installation, during a step 205, from a first operating state E₁ to a second, less dangerous operating state E₂, based on the comparison of at least one characteristic parameter of the climatic conditions surrounding the installation with at least one threshold value. This comparison is symbolised by the comparison step 203 in FIG. 2.

A first example of a climatic parameter consists of the temperature surrounding the installation. When this one rises above a certain temperature threshold Tₛ (approximately 10° c.), chiroptera activity is noticeably increased. One particularly advantageous embodiment can therefore consist of measuring the ambient temperature T in the environment of the wind turbine and comparing it to the temperature threshold value Tₛ. If T>Tₛ, then the wind turbine switches to its second state E₂, which is less dangerous for chiroptera.

A second example of climatic parameter consists of the wind speed surrounding the installation. When this is lower than a certain speed threshold, (approximately 6 m.s⁻¹), the amount of flying insects increases, indirectly raising the level of chiroptera activity.

Another particularly advantageous embodiment can therefore consist of measuring the wind speed Vᵥₑₙₜ in the area of the wind turbine, for example using a wind measuring instrument, and comparing it to the speed threshold value Vₛ. If V_{Vent}<Vₛ, then the wind turbine switches to its second state, which is less dangerous for chiroptera.

The use of other climatic parameters which influence chiroptera activity can of course be envisaged. For example, rain is a factor which causes a reduction in chiroptera activity. One could therefore define a pluviometry threshold beneath which the wind turbine will switch to its second operating state E₂.

The comparison step 203 can simply consist of one of the comparisons described here-above, or of a plurality of comparisons chosen from those described here-above, from which one can decide that, if at least one of the comparisons from the plurality of comparisons carried out reveals that there is a high level of activity by the animal species, the step 205 of switching is implemented.

Once the installation is in its second operating state E₂, we can continue to compare one or several climatic parameters to threshold values, at regular intervals, during a comparison step 209.

As with step 203, this new comparison step 209 can simply consist of one of the comparisons described here-above, or of a plurality of comparisons chosen from those described here-above.

In the first case, if the single comparison reveals a low activity rate by the animal species (for example, if T<Tₛ or if V_{Vent}>Vₛ), it can therefore be useful to switch back the installation, during a step 211, to its first operating state E₁ if this one produces a better efficiency than the second state E₂, as previously explained in step 109.

In the second case, one can decide to switch back the installation to its first operating state E₁ if one, several or all the comparisons made during step 209 reveal a low activity rate of the animal species. The greater the number of comparisons being considered during step 209, the greater the protection of the endangered animal species, to the detriment of the installation's efficiency. For example, in the case where only the temperature and wind speed are considered, the switch over step 211 would not take place if T<Tₛ and if V_{Vent}>Vs.

The environmental parameters used for comparisons 203 or 209 can be determined, for example, using more or less precise meteorological predictions made in the region where the installation is sited.

In a particularly advantageous embodiment, a measuring step 201 of the parameters considered during comparison step 203 is carried out, before this step 203, in the proximity of the installation. This enables a more precise monitoring, in real time, of the installation. A similar step for measuring 207 can be carried out, before the comparison step 209, for the same reasons.

To do this, we can define a threshold distance dₛ, in relation to the installation to be monitored, beneath which all climatic parameter measures carried out are considered as being very close to a measure carried out on the said installation, with a certain tolerance. At a constant altitude (±20 m), in the absence of local climatic discontinuity (slope variation or a variation in slope direction . . . ), a distance threshold such as this can be, for example, of the order of a kilometres.

Advantageously, the optional delaying steps 202 and 206 can be included to insert a time delay T₁′ respectively T₂′, between two successive comparison steps 203 and 207 respectively. This makes it possible to adapt the responsiveness of the system choosing more or less long delays T₁′ and T₂′.

It is noted that with the first category of temporal criteria, activity of the threatened animal species can be measured over a long period in the installation's environment. We can therefore define a periodic time profile which controls the switching of the installation to its second state. Such temporal criteria, because of their stability in time, present the advantage of dispensing with the need to process in real time and simplify the monitoring of the installation.

The second category of climatic parameters concerns those parameters which are non periodic and which vary according to climatic conditions. With such parameters, a measurement in real time in the installation's environment is more appropriate, making it possible to more responsively and more precisely switch over the installation.

It is, of course, possible to use any combination of all of the parameters presented here-above to control the switch over of the wind turbine to its second, less dangerous state. FIG. 4 illustrates an example of such a combination of the various parameters.

In this FIG. 4, a tree structure represents six successive criteria being considered to determine the wind turbine's operating state.

The three first criteria C₁, C₂ and C3 are of a temporal nature and respectively concern the annual period of high activity, the daily period of high activity and the two periods of very high activity included in the period between sunset and 2½ hours after sunset and between 1½ hours before sunrise and sunrise.

The two following criteria C₄ and C₅ are climatic and respectively concern the wind speed V_{Vent} and the temperature in the vicinity of the installation. A sixth optional climatic criterion C₆, linked to rain, can also be considered.

Depending on all of these criteria, the wind turbine will set itself to a specific operating state. Case 301 corresponds to a low bat activity rate, making it possible to leave the wind turbine in its E₁ state of higher productivity.

Case 302 is the case where climatic and time conditions are brought together so that the rate of bat activity is high enough to cause a high mortality rate when the wind turbine is used in its E1 state. In this case, the wind turbine is switched to an E2 state in which it is less dangerous for the bats, for example, in which the rotation speed of the blades is reduced or null.

Finally, case 303 is a specific case which takes into consideration, in addition to bat activity rates, the wind turbine's efficiency. Indeed, the first four criteria C₁-C₄ lead to this case 303 in the tree structure revealing a high potential activity rate for bats. Such an activity rate can be reduced as a result of other climatic conditions. However, the C₄ criterion for wind speed is also a determining criterion for the installation's efficiency, since below a given wind speed threshold (which here is 4 m/s), the wind turbine's efficiency is noticeably lower. In such a case 303, the wind turbine's rotation is stopped, due either to its dangerousness to bats or to efficiency reasons.

A potential disadvantage of the method according to the invention lies in that the act of switching from a second operating state E₂ can cause a loss of efficiency.

Therefore, in the given wind turbine example, an optimum efficiency in a first, normal operating state E₁ of which the second operating state E₂ consists of completely stopping the blades, the loss of efficiency will simply correspond with that which the wind turbine would have had, in its normal state, during the switching period.

Such a loss of efficiency can be amplified in respect of the achieved gain in the preservation of the animal species. In certain cases, it may be appropriate to opt for a compromise between the installation's efficiency and the dangerousness of said installation, for reasons of investment costs and project viability.

It can also be advantageous to implement switch over, amongst other reasons, based on other criteria Cᵢ′ linked to the installation's efficiency.

In a particular embodiment similar to this of FIG. 2, the installation's efficiency in its normal operating state E₁ can be characterised on one hand by a certain time range, based on experience or the extrapolation of measurements over a long period of time, making it possible to define a period of time during which the efficiency is lower than a given threshold Rₛ. In this period of time, any switch over to a second operating state E₂ will not be problematic, in as much as the installation's efficiency is naturally already reduced.

Therefore, the time range during which the activity of a species is important (and may therefore require that the installation is switched to a second, less dangerous operating state E₂) can coincide in part, or in totality, with a time range during which the installation's efficiency is lower. In such a case, it is advantageous to switch the installation to its second state during a time range which corresponds with the two previously described time ranges.

This principle is illustrated in FIG. 5, in which three digital timing diagrams respectively represent the activity of the endangered species, the installation's efficiency in its normal operating state E₁ and the operating state E of the installation being monitored by a method according to the present invention.

In the first digital timing diagram, an activity parameter Act goes from a low level of activity A₁ to a high level of activity A₂ during a time period d₂ which corresponds with [t_{R,i}; t_{R,2}].

In the second digital timing diagram, an example of the efficiency variation R of the installation is described on a time basis. This efficiency goes from a maximum value Rₘₐₓ to a minimum Rₘᵢₙ, passing through an efficiency threshold value Rₛ, which can be determined by the installation's operator according to the limitations of the installation project or by the operators own limits. The installation's efficiency is lower than the threshold value Rₛ during a period of time d₂ corresponding with [t_{R,1};t_{R,2}].

If we wish to monitor the installation in such a way as to optimise the compromise between protection of the species and the installation's efficiency, the time periods d₁ and d₂ described here-above, must be overlaid, which is illustrated in the third digital timing diagram.

In this third digital timing diagram, the evolution of time E(t) between these two installation operating states is represented.

On this digital timing diagram we can see three zones Z₁, Z₂, Z₃. A first zone Z₁ recovers the cases where the efficiency R exceeds the threshold Rₛ and activity of the animal species is low. In such a case, the installation is operated in its E₁ state producing an optimum efficiency.

A second zone Z₂ recovers the opposite case where the efficiency R is under the threshold Rₛ and activity of the animal species is important. In such a case, the installation is switched to its operating state E₂, increasing protection of the animal species at the same time as causing a lower reduction in efficiency.

Finally, a third zone Z₃ is defined in which activity of the animal species is important, but the efficiency R exceeds the threshold Rₛ.

In such a case, a compromise must be found and a decision taken. If it is sought to give priority to the protection of the animal species to the detriment of the installation's efficiency, it is necessary to switch the installation to the E₂ state. Conversely, if it is sought to give priority to the installation's efficiency in view of the low potential for increasing protection of the animal species, the installation is operated in its normal E₁ state.

This last choice is illustrated in FIG. 5, where the time period d₃ for switching to the E₂ state corresponds with the time overlay of periods d₁ and d₂, thus taking into consideration both the activity of the animal species and the installation's efficiency.

Finally we can refer to FIG. 6 which illustrates a system 400 in which the method described here-above is implemented.

The system 400 comprises at least one wind turbine 401 (a single wind turbine being represented as a purely illustrative example) connected to a distance monitoring device 410.

This monitoring device 410 includes at least the means for processing 411 (for example, a processor) set up to analyse all switch over criteria as previously described and capable of sending the wind turbine 401 a signal S₁ to switch to a first operating state E₁ or a signal S₂ to switch to a less dangerous second operating state E₂.

The monitoring device 410 can include the means of memorising 413, connected to the means of processing, to store in memory various switching criteria Ci. These means 413 are particularly appropriate for the case of predetermined temporal criteria, as well as for the Ci′ criteria linked to the wind turbine's efficiency. The switching dᵢ time periods, such as previously described, can thus be recorded in the means 413 and used by the processing means 411 so that these means send the switching signals S₁ or S₂ at the right time, for example, at the start and/or at the end of these switch over dᵢ time periods.

Such means 413, in which the switch over di time periods are memorised, dispense with the need to adapt each wind turbine to include an infrared detection device, as evoked in prior art.

Furthermore the system can include a measuring module 403, sited in proximity to the wind turbine 401 and capable of measuring given climatic parameters, for example, pluviometry P, temperature T or wind speed Vᵥₑₙₜ. These parameters are sent to the device 410 so that the processing means 411 can analyse them and decide to send a switch over signal Si or S₂, in real time, according to the climatic conditions shown by these parameters and which affect chiroptera activity on this particular site.

Such a measuring module 403 should simply be placed at distance sufficiently close to the wind turbine, and/or use sensors already present on the wind turbine, to measure sufficiently characteristic climatic parameters, for example, at a distance less than the threshold dₛ as defined here-above.

This simplified implementation presents the advantage of dispensing with the need to adapt the wind turbine by fitting it with a detection device. Moreover, a single module 403 can be used for several wind turbines 401 situated in close proximity to each other, which is much less costly than fitting detection devices to each wind turbine.

Environmental parameters, instead of being used in real time to monitor the wind turbine, can also be statistically analysed in order to decide which switch over periods dᵢ to memorise in the means 413.

The invention also concerns a computer programme which includes instructions for carrying out the steps of a method such as is described here-above.

Such a computer programme can be uploaded via a telecommunication network, stored in the memory of a central unit or on a memory device designed to cooperate with a reader of the said central unit.

In particular, when a device for monitoring an installation already exists, such a computer programme can be loaded into the monitoring device's processor in order to control the installation according to the method of the present invention.

Clearly, the invention is not limited to the examples of embodiment described and represented above, on the basis of which we can envisage other modes and other forms of embodiment, without departing from the scope of the invention.

Thus, the example of controlling a wind turbine to reduce the mortality rate of chiroptera is supplied purely as an illustration. In the case of a wind turbine, the present invention can be applied to all flying species which are liable to collide with the blades of the wind turbine, for example migratory birds.

Furthermore, the present invention can be applied on installations other than wind turbines. All installations presenting an operating mode in which part of the installation is mobile in a particular operating state can potentially put an animal species in danger. This could be the case of a dam, a tidal power station or energy converter for example, which can represent a threat for aquatic species.

Moreover, the criteria for switching the installation to a less dangerous operating state given here-above, whether they be of a climatic or temporal nature, are non limitative and all other criteria which reflect, depend on or affect the activity of an animal species threatened by the installation can be used in the scope of the present invention.

Furthermore, the method only refers to two operating states E₁ and E₂ in order to facilitate understanding of the invention. It is however, completely possible to monitor an installation presenting any number of operating states, each of which represent a given level of dangerousness for an animal species and of which the choice of operating state is based on criteria linked to the activity of the species and the installation's efficiency such as is described here-above.

1. A method of monitoring an installation according to the activity of an animal species, the said installation presenting at least a first state of operation (E₁) and a second state of operation (E₂) respectively associated to a first and second level of dangerousness due to interaction between the installation and the animal species, the second level of dangerousness being lower than the first level of dangerousness, the method comprising a step for switching (107) the installation from the first state of operation (E₁) to the second state of operation (E₂), characterised in that the switch over (107) is implemented on the basis of at least one criterion (Cᵢ) linked to the activity of the animal species.

2. A method of monitoring an installation according to claim 1, characterised in that the switch over is implemented during at least one time period (dᵢ) determined according to the activity of the animal species.

3. A method of monitoring an installation according to claim 2, characterised by a prior step of determining (101) the time period (dᵢ) using a measurement of a parameter of activity of the animal species during a given time period.

4. A method of monitoring an installation according to claim 1 characterised in that the switch over is implemented according to the comparison (203) of at least one measured climatic parameter (T,Vᵥₑₙₜ) with at least one threshold value (T_{S},V_{S}).

5. A method of monitoring an installation according to claim 4, characterised by a step of measuring (201) a climatic parameter (T,V_{Vent}) at a distance inferior to a proximity distance limit (dₛ).

6. A method of monitoring an installation according to claim 4, characterised in that the switch over is implemented if the measured wind speed (V_{Vent}) is lower than a first threshold value (Vs).

7. A method of monitoring an installation according to claim 4 characterised in that the switch over is implemented if the measured temperature (T) is higher than a threshold value (Tₛ).

8. A method of monitoring an installation according to claim 1, characterised in that the switch over is also implemented on a basis of a criterion (Ci′) linked to the installation's efficiency.

9. A method of monitoring an installation according to claim 8, characterised in that the switch over is implemented if wind speed (V_{Vent}) is lower than a second threshold value.

10. A method of monitoring an installation according to claim 1, characterised in that the second operating state (E₂) corresponds with an off state of the installation.

11. A method of monitoring an installation according to claim 1, characterised in that the installation is an installation which converts wind energy into electrical energy and in that the animal species is a flying species.

12. A method of monitoring an installation according to claim 11 characterised in that the flying animal species belongs to the order chiroptera.

13. A monitoring device (410) capable of being connected to at least one installation (401) and switching the said installation from a first operating state (E₁) to a second operating state (E₂), characterised in that it comprises the means for processing (411) capable of implementing a method according to claim 1 and sending an operating state switch over signal (S₁) to the said installation.

14. A dangerousness monitoring system (400) based on the activity of an animal species, comprising at least one installation (401) which can be operated in at least a first operating state (E₁) and a second operating state (E₂) associated respectively to a first and a second level of dangerousness due to interaction between the installation and the animal species, the second level of dangerousness being lower than the first level of dangerousness, the system comprising a monitoring device (410) according to claim 13, connected to the said installation and capable of sending it a signal to switch states.

15. A computer programme which can be downloaded via a telecommunication network and/or stored in the memory of a central unit and/or stored on a memory device designed to cooperate with a reader of the said central unit, characterised in that it includes instructions for implementing the steps of a method according to claim 1.

16. A method of monitoring an installation according to claim 2, characterised in that the switch over is implemented according to the comparison (203) of at least one measured climatic parameter (T,V_{Vent}) with at least one threshold value (T_{S}, V_{S}).

17. A method of monitoring an installation according to claim 3, characterised in that the switch over is implemented according to the comparison (203) of at least one measured climatic parameter (T,V_{Vent}) with at least one threshold value (T_{S}, V_{S}).

18. A method of monitoring an installation according to claim 5, characterised in that the switch over is implemented if the measured wind speed (Vᵥₑₙₜ) is lower than a first threshold value (Vs).

19. A method of monitoring an installation according to claim 5 characterised in that the switch over is implemented if the measured temperature (T) is higher than a threshold value (Tₛ).

20. A method of monitoring an installation according to claim 6 characterised in that the switch over is implemented if the measured temperature (T) is higher than a threshold value (Tₛ).
